(19) United States
(12) Patent Application Publication
(10) Pub. No.: US 2026/0065751 A1
(43) Pub. Date: Mar. 5, 2026

(54) SELECTABLE PERSISTENT UPGRADES SYSTEMS AND METHODS IN ELECTRONIC GAMING

(71) Applicant: Aristocrat Technologies, Inc., Las Vegas, NV (US)

(72) Inventors: Nicholas Farina, Granger, IN (US); Scott Hopkins, Austin, TX (US); Erick Ching, Cedar Park, TX (US); Jennifer Mizzi, Ewa Beach, HI (US); Rogelio Decasa, JR., Renton, WA (US); Steven Richardson, Round Rock, TX (US); Ginette McKay, Austin, TX (US); Hanna Sanborn, Georgetown, TX (US); Nathan Warms, Austin, TX (US); Zachary Smith, Austin, TX (US); Kelly Lockheed, Elkridge, MD (US); Carlyn Albright, Reno, NV (US); Deanna Hickox, Georgetown, TX (US)

(21) Appl. No.: 19/309,143

(22) Filed: Aug. 25, 2025

Related U.S. Application Data
(60) Provisional application No. 63/688,924, filed on Aug. 30, 2024.

(51) Int. Cl. G07F 17/32

(52) U.S. Cl. CPC G07F 17/3267; G07F 17/3213

(57) ABSTRACT

An electronic gaming system is provided. The electronic gaming system may include at least one memory storing a plurality of sets of reel strips and at least one processor. The at least one processor may be configured to, in response to a bonus game being triggered, cause a display device to prompt selection of an upgrade type of a plurality of upgrade types, receive a selection of a first upgrade type of the plurality of upgrade types, randomly determine a first upgrade based on the first upgrade type, determine a first state based on the first upgrade type or the first upgrade, select a first set of reel strips of the plurality of sets of reel strips based on the first state, and generate and display in a game matrix a first game outcome based on the first set of reel strips and the first upgrade.

### TECHNICAL FIELD

The field of disclosure relates generally to electronic gaming, and more specifically, to systems and methods in electronic gaming that enable user-selectable persistent upgrades while maintaining a target return to player (RTP).

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming system is provided. The electronic gaming system may include at least one memory storing a plurality of sets of reel strips and at least one processor in communication with the at least one memory. The at least one processor may be configured to, in response to a bonus game being triggered, cause a display device to prompt selection of an upgrade type of a plurality of upgrade types, receive a selection of a first upgrade type of the plurality of upgrade types, randomly determine a first upgrade based on the first upgrade type, determine a first state based on the first upgrade type or the first upgrade, select a first set of reel strips of the plurality of sets of reel strips based on the first state, and generate and cause the display device to display in a game matrix a first game outcome based on the first set of reel strips and the first upgrade.

In another aspect, a method for providing user-selectable persistent upgrades in a bonus game is provided. The method may be performed by at least one processor in communication with at least one memory storing a plurality of sets of reels strips. The method may include, in response to a bonus game being triggered, causing a display device to prompt selection of an upgrade type of a plurality of upgrade types, receiving a selection of a first upgrade type of the plurality of upgrade types, randomly determining a first upgrade based on the first upgrade type, determining a first state based on the first upgrade type or the first upgrade, selecting a first set of reel strips of the plurality of sets of reel strips based on the first state, and generating and causing the display device to display in a game matrix a first game outcome based on the first set of reel strips and the first upgrade.

In another aspect, at least one non-transitory computer-readable storage media having computer-executable instructions embodied thereon is provided. When executed by at least one processor in communication with at least one memory storing a plurality of sets of reels strips, the computer-executable instructions may cause the at least one processor to, in response to a bonus game being triggered, cause a display device to prompt selection of an upgrade type of a plurality of upgrade types, receive a selection of a first upgrade type of the plurality of upgrade types, randomly determine a first upgrade based on the first upgrade type, determine a first state based on the first upgrade type or the first upgrade, select a first set of reel strips of the plurality of sets of reel strips based on the first state, and generate and cause the display device to display in a game matrix a first game outcome based on the first set of reel strips and the first upgrade.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a flowchart illustrating an example process for evaluating and displaying an electronic game having selectable persistent upgrades according to an embodiment of the present disclosure.

FIG. 5 is an exemplary user interface for presenting selectable options for a bonus game included in an electronic game according to an embodiment of the present disclosure.

FIG. 6 is another exemplary user interface for presenting a wheel for a bonus game included in an electronic game according to an embodiment of the present disclosure.

FIG. 7A is an exemplary user interface or screenshot of a base reel game displayed on an electronic gaming machine that triggers a bonus game according to an embodiment of the present disclosure.

FIG. 7B is an exemplary user interface or screenshot of selectable options for a bonus game triggered by the base reel game shown in FIG. 7A according to an embodiment of the present disclosure.

FIG. 7C is an exemplary user interface or screenshot of a wheel for the bonus game in a first state and triggered by the base reel game shown in FIG. 7A according to an embodiment of the present disclosure.

FIG. 7D is an exemplary user interface or screenshot of the bonus game in the first state according to an embodiment of the present disclosure.

FIG. 7E is an exemplary user interface or screenshot of selectable options for the bonus game according to an embodiment of the present disclosure.

FIG. 7F is an exemplary user interface or screenshot of the wheel for the bonus game in a second state according to an embodiment of the present disclosure.

FIG. 7G is an exemplary user interface or screenshot of the bonus game in the second state according to an embodiment of the present disclosure.

FIG. 7H is an exemplary user interface or screenshot of selectable options for the bonus game according to an embodiment of the present disclosure.

FIG. 8A is an exemplary user interface or screenshot of a wheel for the bonus game in a first state according to another embodiment of the present disclosure.

FIG. 8B is an exemplary user interface or screenshot of the bonus game in the first state based on the wheel in FIG. 8A, according to an embodiment of the present disclosure.

FIG. 8C is an exemplary user interface or screenshot of a wheel for the bonus game in a second state according to an embodiment of the present disclosure.

FIG. 8D is an exemplary user interface or screenshot of the bonus game in the second state based on the wheel in FIG. 8C, according to an embodiment of the present disclosure.

FIG. 9A is an exemplary user interface or screenshot of a wheel for the bonus game in a first state according to an additional embodiment of the present disclosure.

FIG. 9B is an exemplary user interface or screenshot of the bonus game in the first state based on the wheel in FIG. 9A, according to an embodiment of the present disclosure.

FIG. 9C is an exemplary user interface or screenshot of a wheel for the bonus game in a second state according to an embodiment of the present disclosure.

FIG. 9D is an exemplary user interface or screenshot of the bonus game in the second state based on the wheel in FIG. 9C, according to an embodiment of the present disclosure.

FIG. 10 is an exemplary user interface or screenshot of a bonus game in a third state according to an embodiment of the present disclosure.

### DETAILED DESCRIPTION

Described herein are systems and methods in electronic gaming that enable user-selectable persistent upgrades while maintaining a target return to player (RTP). When a bonus game is triggered, a user is prompted to select from different types of possible persistent upgrades that, once activated, remain active and affect gameplay throughout the remainder of the bonus game. These types of upgrades may include, for example, floating wild symbols, adding rows to a game matrix, and/or adding a multiplier. Once an upgrade type is selected, a random determination is performed to determine what upgrade will be added. For example, a number of matrix positions of floating wilds, a number of rows to add, or an amount by which to increase a multiplier may be determined. Once the upgrade has been determined, the system may determine a state of the game defined by which upgrades have been added and control RTP of the game based on this determined state, for example, by selecting a set of reel strips having a predefined association with the state of the game to use in the next spin or game instance of the bonus game. This selection of an upgrade type, random determination of a persistent upgrade to add, and game evaluation based on a current state of the bonus game may be repeated for each spin or game instance of the bonus game.

In exemplary embodiments, an electronic gaming system may include at least one memory storing a plurality of sets of reel strips and at least one processor in communication with the at least one memory. The at least one processor may be configured to, when a bonus game is triggered, prompt a user to input and receive a selection of a first upgrade type of the plurality of upgrade types. The upgrade types may include, for example, floating wild symbols, adding rows to a game matrix, and/or adding a multiplier. The at last one processor may then randomly determine a first upgrade based on the first upgrade type, such as a number of floating wild symbols to add, a number of rows to add, or a number by which to increase a multiplier.

The system may determine a first state based on the first upgrade type or the first upgrade and select a first set of reel strips of the plurality of sets of reel strips based on the first state. For example, each possible reel state may have a predefined association with a corresponding set of reel strips stored in the at least one memory. The processor may then generate and cause the display device to display, in a game matrix, a first game outcome based on the first set of reel strips and the first upgrade. The first game outcome may include reel symbols displayed in respective matrix positions selected based on randomly determined stopping positions of reels of the selected reel set, as well as effects associated with active upgrades such as floating wilds displayed in symbol positions.

In response to displaying the first game outcome, the at least one processor may cause a display device to prompt another selection of an upgrade type of the plurality of upgrade types, receive a selection of a second upgrade type of the plurality of upgrade types, and randomly determine a second upgrade based on the second upgrade type. The at least one processor may then determine a second state based on any currently active upgrades, or in other words, based on the first state and on the second upgrade type or the second upgrade. The at least processor may then select a second set of reel strips of the plurality of sets of reel strips based on the second state and generate and cause the display device to display a second game outcome in a similar manner as with described with respect to the first game outcome. This process may be completed by the at least one processor for each subsequent instance of the bonus game. The bonus game may continue for a predefined number of game instances or spins and/or end in response to a trigger such as a random determination.

A technical problem with user selectable upgrades is a difficulty in controlling RTP due to the many possible factors that can affect RTP. For example, there are a large number of potential combinations of selections of upgrade types that may be selected by a user and a large number of combinations of resulting upgrades that may be added (e.g., in response to respective random determinations), and each of these combinations may have a unique effect on an overall RTP of the game. The system described herein solves this technical problem by evaluating game instances differently based on a current state of the game, such as based on which upgrade types have been selected and/or which upgrades have been added. For example, the system may select a different set of reel strips to use in a spin or game instance of the bonus game that are associated with and selected to meet a target RTP based on the current state of the game.

Another technical problem exists in increasing variability and apparent randomness of display outcomes. By enabling a user to select an upgrade type and then randomly determining a persistent upgrade to apply based on the selected type may increase a number of different display outcomes that may become available without requiring any changes, such as more advanced computations, to the underlying bonus game. Further, as described herein, a random number generator and lookup table and/or another algorithm may be used to determine how long the bonus game lasts, for example, by performing a random determination with each game instance and/or utilizing another random determination, such as that used to determine the upgrade. This aspect may provide additional randomness and variability in the display outcome. Accordingly, the system described herein solves this technical problem by increasing the randomness and/or variability of display outcomes that may be presented.

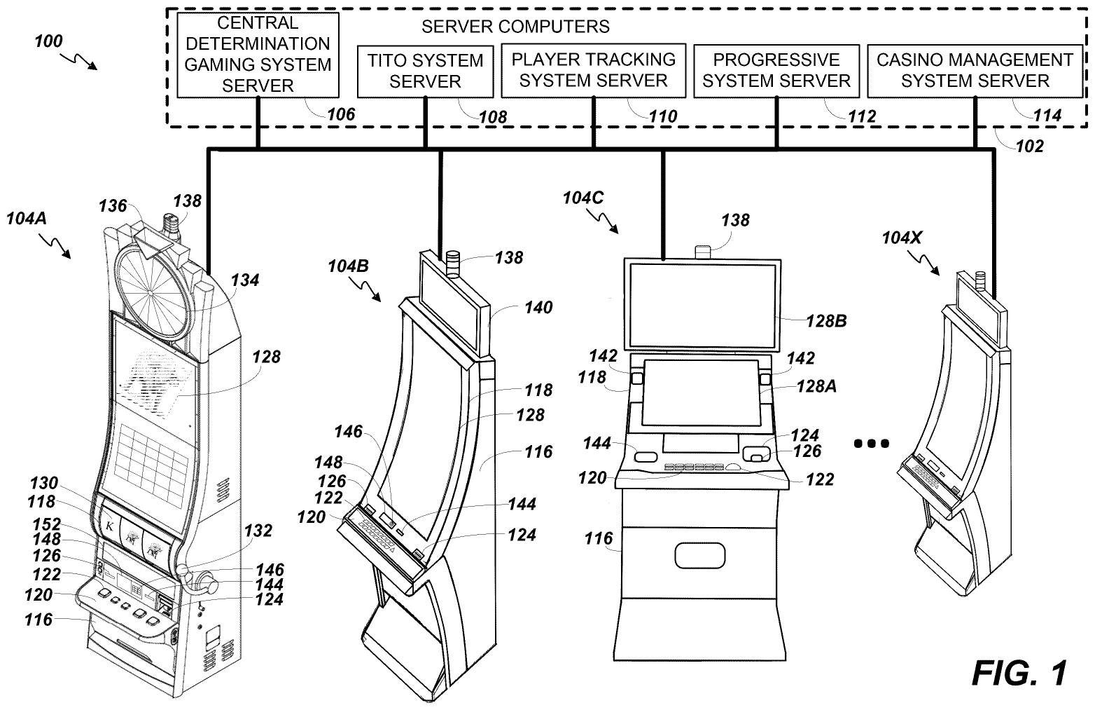

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out”printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

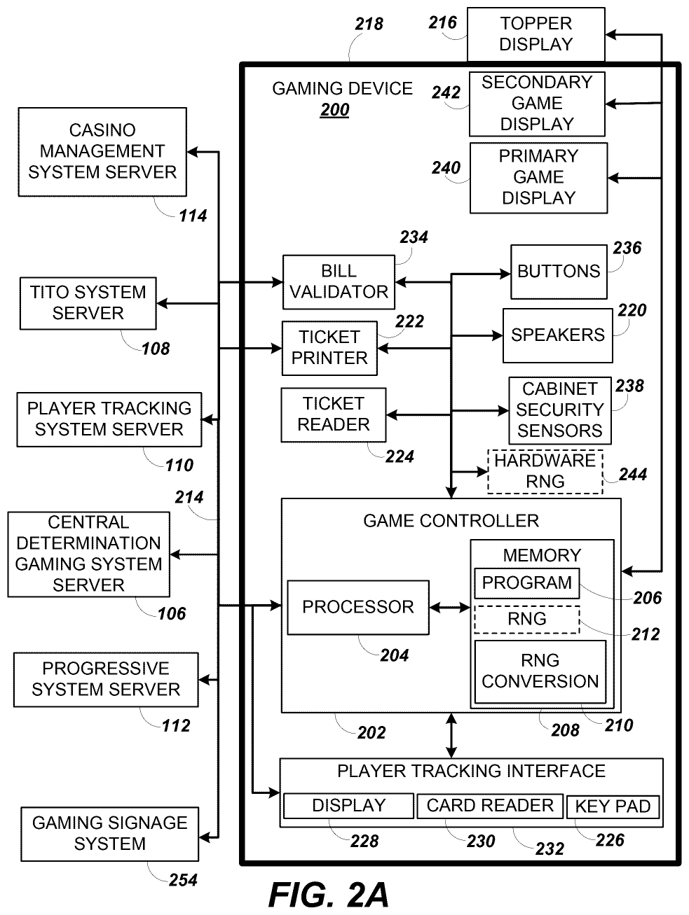

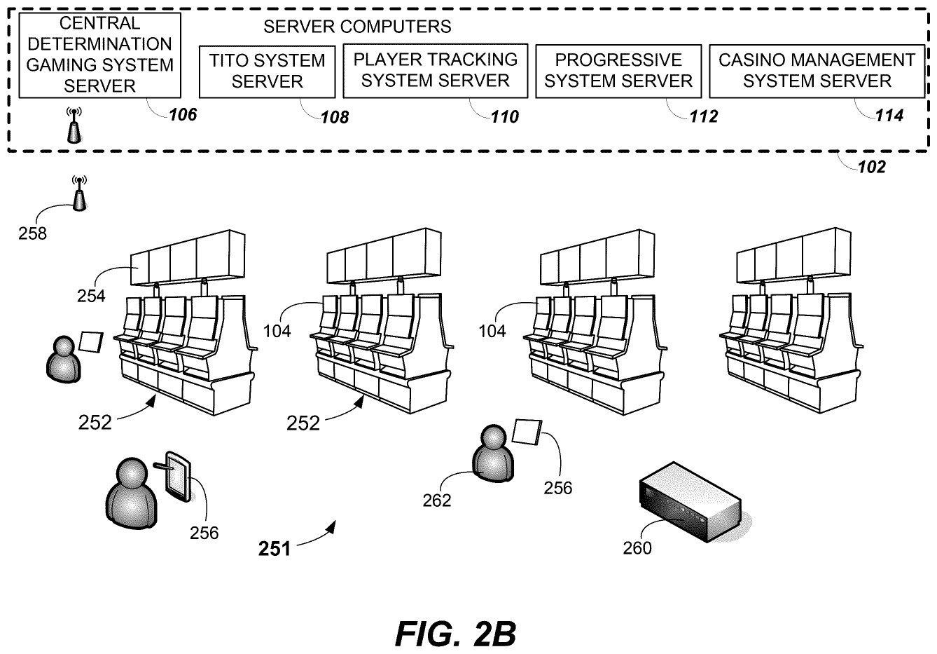

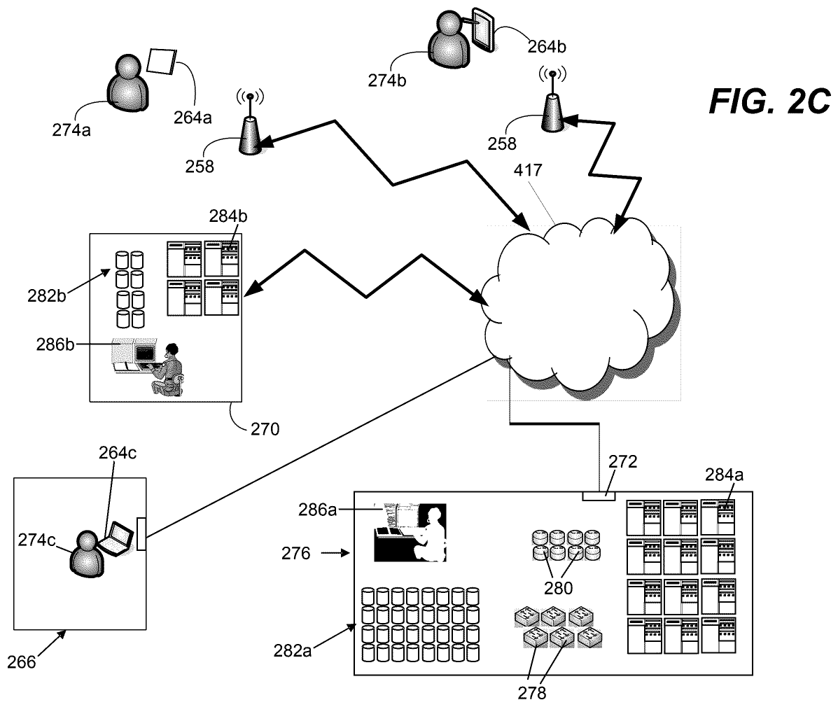

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. Amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

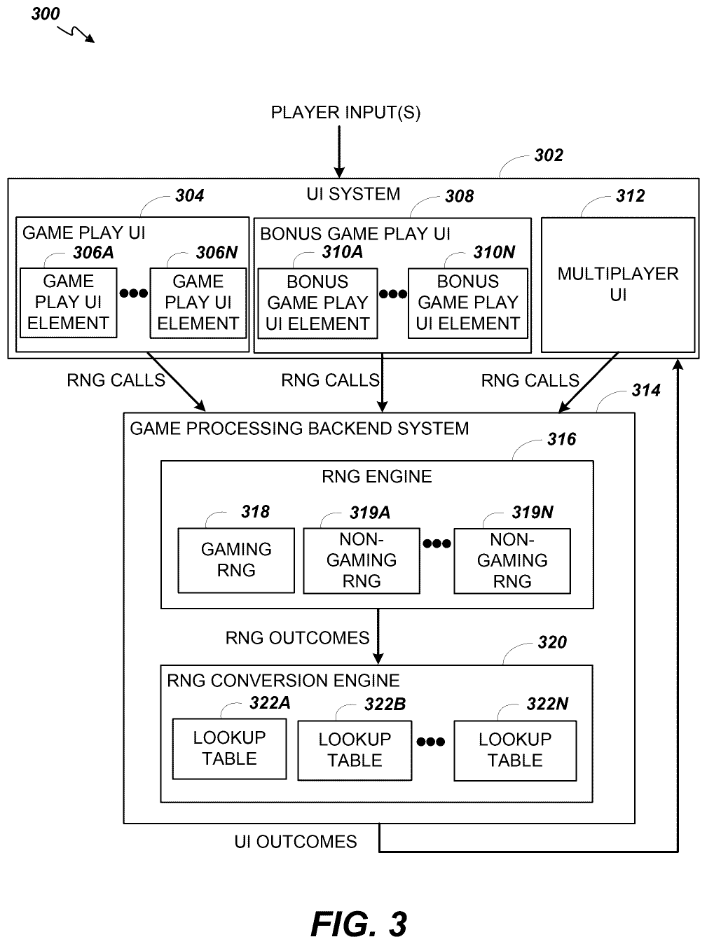

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

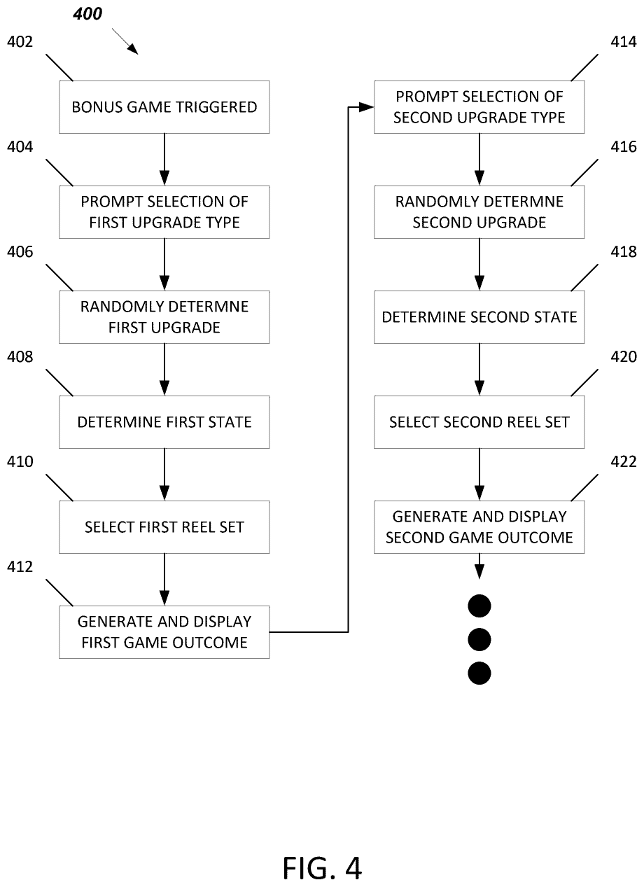

FIG. 4 is a flowchart illustrating an example process 400 for evaluating and displaying an electronic game having selectable persistent upgrades. Process 400 may be performed by system 100 (shown in FIG. 1), for example, using gaming devices 104 and/or mobile gaming devices 256 (shown in FIG. 2).

In the exemplary embodiment, system 100 may determine that a bonus game has been triggered in response to a game instance on one of gaming devices 104 and/or mobile gaming devices 256 (block 402). For example, the bonus game may be triggered in response to a certain symbol pattern being displayed in a base game and/or a separate random determination (e.g., RNG outcome) performed in parallel with a game instance of the base game.

In response to the bonus game being triggered, system 100 may cause gaming device 104 and/or mobile gaming device 256 to prompt selection of an upgrade type of a plurality of upgrade types and receive a selection of a first upgrade type of the plurality of upgrade types (block 404). The upgrade types may include, for example, floating wilds (e.g., persistent wild symbols that, once displayed in a matrix position, remain displayed until an end of the bonus game), adding rows or otherwise changing a size of a game matrix of the bonus game, and/or adding to a multiplier that is applied to an award outcome associated with the bonus game.

In response to this selection, system 100 may randomly determine a first upgrade based on the first upgrade type. This determination may be accompanied by a display outcome such as a wheel spin animation, as described in further detail below. Any awarded upgrades may persist throughout the bonus game. For example, if the first upgrade type is floating wilds, one or more RNG calls and table lookups may be performed to determine how many floating wilds to add to the game matrix and in which matrix positions to add any of these floating wilds.

If the first upgrade type is adding rows to the matrix, one or more RNG calls and table lookups may be performed to determine how many rows to add. For example, the matrix by default may be a three by six grid with three rows, and additional rows may be added. In some embodiments, a maximum number of rows, such as eight total rows may be present. For example, if there are initially three rows, a maximum number of five rows may be added.

If the first upgrade type is a multiplier, one or more RNG calls and table lookups may be performed to determine by how much to increase the multiplier. For example, in an initial state, the bonus game may have a 1× multiplier, and the multiplier may be increased incrementally up to a maximum of a 30× multiplier.

After determining the first upgrade, system 100 may determine a first state based on the first upgrade type or the first upgrade (block 408). In other words, the state may be defined by which type of upgrade was selected, the specific upgrade that was determined, or both. System 100 may select a first set of reel strips of the plurality of sets of reel strips based on the first state (block 410). For example, each state may be associated with a corresponding set of reel strips in the memory. This association may be predetermined so that, no matter which type of upgrade is selected by the player and/or which upgrade is awarded by the system, the bonus game may still achieve an average target RTP. For example, if an upgrade is achieved that results in a relatively large increase in RTP (e.g., a large multiplier), reels may be selected that counterbalance this large increase in RTP. By selecting the reels based on a predefined association with the state of the game, no additional computations need to be performed to ensure the target RTP is met. In some embodiments, alternative ways for counterbalancing the RTP associated with an upgrade may be utilized.

System 100 may generate and cause gaming device 104 and/or mobile gaming device 256 to display in a game matrix a first game outcome based on the first set of reel strips and the first upgrade (block 412). For example, one or more RNG calls and table lookups may be performed to determine stopping positions of the reel strips, and the resulting pattern, including any persistent symbols such as floating wilds, may be evaluated using one or more pay tables and any active effects such as multipliers to determine an award.

After displaying the first game outcome, system 100 may cause gaming device 104 and/or mobile gaming device 256 to prompt another selection of an upgrade type of the plurality of upgrade types and receive a selection of a second upgrade type (block 414). The selectable upgrade types may be the same or some subset of those previously displayed (e.g., if one type of upgrade has reached its maximum, this type may not be displayed). Any subsequent prompts to select an upgrade type may also be performed similarly.

System 100 may randomly determine a second upgrade based on the second upgrade type (block 416). This determination may be performed in a similar manner as described with respect to the first determination of an upgrade. Any subsequent determinations may also be performed similarly. In some embodiments, this determination may be based in part on a current state of the game to further control RTP. For example, if previous upgrades have resulted in a relatively large increase in RTP, the chances of awarding further upgrades resulting in a large RTP may be reduced, for example, by selecting a different lookup table based on the current state.

System 100 may determine a second state based on the first state and on the second upgrade type or the second upgrade (block 418). In other words, the state may be defined by which type of upgrade was selected for each previous selection, the specific upgrade that was determined for each previous selection, or both. System 100 may select a second set of reel strips of the plurality of sets of reel strips based on the first state (block 420) in a similar manner to the first set of reel strips, that is, based on a predefined association between the second set of reel strips and the second state. Because the second state accounts for all the active upgrades including the newly added second upgrade, the second reel strip may be selected to account for a combined increase in RTP of all the active upgrades. In this manner, the target RTP may be met following the second and any subsequent upgrades (e.g., by selecting different sets of reel strips based on subsequent states following subsequent upgrades). In some embodiments, alternative ways for counterbalancing the RTP associated with a current state of the bonus game (e.g., which upgrades are active) may be utilized.

System 100 may generate and cause gaming device 104 and/or mobile gaming device 256 to display in the game matrix a second game outcome based on the second set of reel strips and the second upgrade (block 422). The second game outcome may be generated and evaluated in a similar manner as the first game outcome, and any subsequent game outcomes may be determined and evaluated likewise. In some embodiments, blocks 414-422 may be repeated a predefined number of times and/or until a triggering event results in the bonus game ending. For example, each random determination of an upgrade (such as that of block 416) may have some chance of triggering an end of the bonus feature, with the specific probability selected to achieve the target RTP. Each subsequent instance of the bonus game may enable the user to select a new upgrade that will be active for all subsequent instances, so many different combinations of selected upgrade types and resulting upgrades may occur. Nonetheless, a target RTP may be maintained by selecting reels and/or making other adjustments to the game evaluation based on a current state of the bonus game.

In some embodiments, the bonus game may include jackpots or free games, which may be triggered by the same determination used to determine which upgrade to award. For example, if a wheel spin animation is used, one or more wheel landing positions may correspond to awarding a jackpot or free game.

In some embodiments, the upgrades described herein may also be triggered during the base game, which in addition to increasing variability of the base game, may also serve to inform the user about the effects of the different upgrades before the user needs to select an upgrade type once the bonus game is triggered.

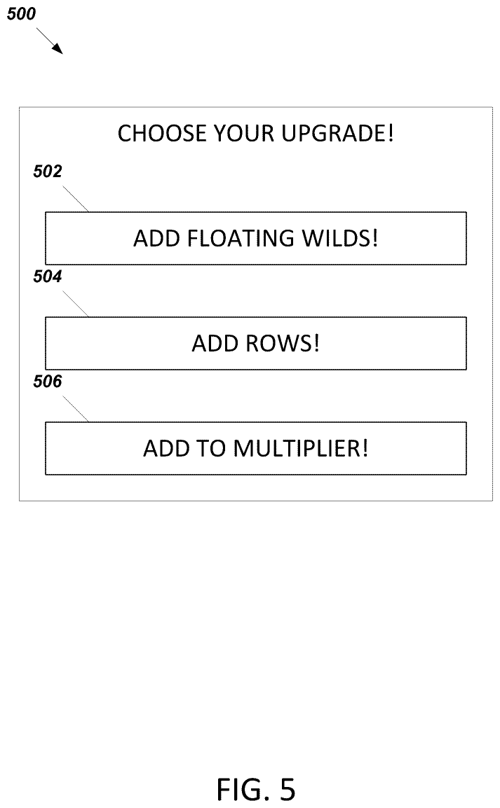

FIG. 5 is an example user interface 500, which may be used to prompt a selection of an upgrade type. User interface 500 may be displayed, for example, by gaming device 104 and/or mobile gaming device 256. User interface 500 includes a first selectable option 502 to add floating wilds, a second selectable option 504 to add rows, and a third selectable option 506 to increase a multiplier. In embodiments where there are additional types of selectable upgrades, additional corresponding selectable options may be displayed within user interface 500. In situations where one or more of first selectable option 502, second selectable option 504, and/or third selectable option 506 are unavailable, for example, due to the corresponding upgrade already having reached its maximum, the unavailable selectable option may not be displayed.

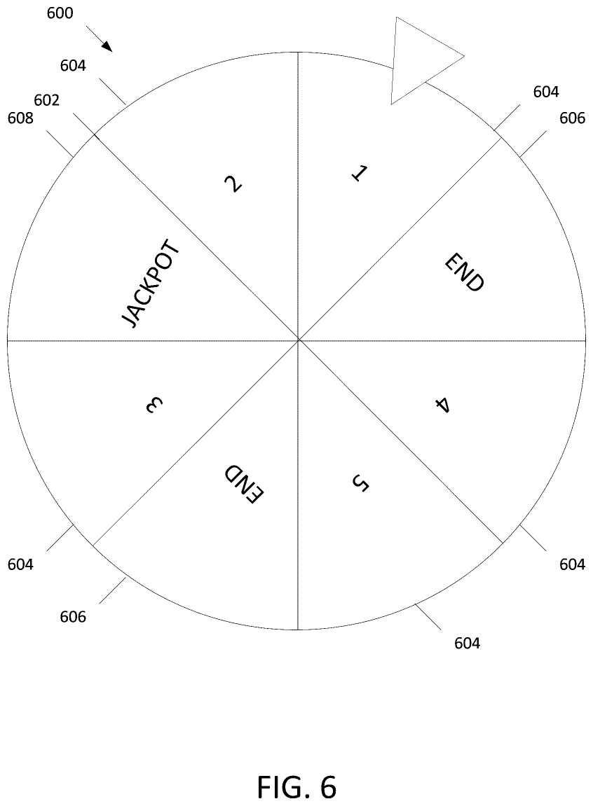

FIG. 6 is an example user interface 600, which may be displayed in response to a user selecting an upgrade type via user interface 500, and may be used to display an outcome of a determination of an upgrade. User interface 500 may be displayed, for example, by gaming device 104 and/or mobile gaming device 256. User interface 600 includes a wheel 602 having various landing positions each corresponding to a possible outcome, which may be determined randomly as described above. Wheel 602 may rotate, with the determination outcome being indicated based on the final displayed position of wheel 602. Wheel 602 includes number positions 604, which may indicate a number associated with an upgrade that has been determined.

For example, if the user has selected floating wilds, number positions 604 may indicate that one, two, three, four, or five floating wilds will be added. If the user has selected adding rows, number positions 604 may indicate that one, two, three, four, or five rows will be added. If the user has selected increasing a multiplier, number positions 604 may indicate that the multiplier will be incremented by one, two, three, four, or five. While number positions 604 having values of one, two, three, four, and five are shown for purposes of illustration, other number values, including zero, may be displayed. In some embodiments, multiple instances of a certain number value may be displayed. For example, more number positions 604 may correspond to lower number values (e.g., one) than higher number values (e.g., five).

Wheel 602 may further include one or more end positions 606, which may indicate that a determination has been made to end the bonus game. For example, in some embodiments, there may be no predefined number of game instances of the bonus game, but each selection of an upgrade may trigger a chance that the bonus game is ended. In some embodiments, there may be both a predefined number of bonus game instances and a chance that the bonus game ends in response to an attempted selection of an upgrade. In some embodiments in which the bonus game ends in response to a predetermined number of game instance being performed or in response to another trigger (e.g., a time limit, etc.), user interface may not include end positions 606.

Wheel 602 may further include one or more jackpot positions 608, which may indicate that system 100 has determined to award a jackpot. In some embodiments, other bonus features, such as free games, may have associated positions within wheel 602 similar to jackpot positions 608.

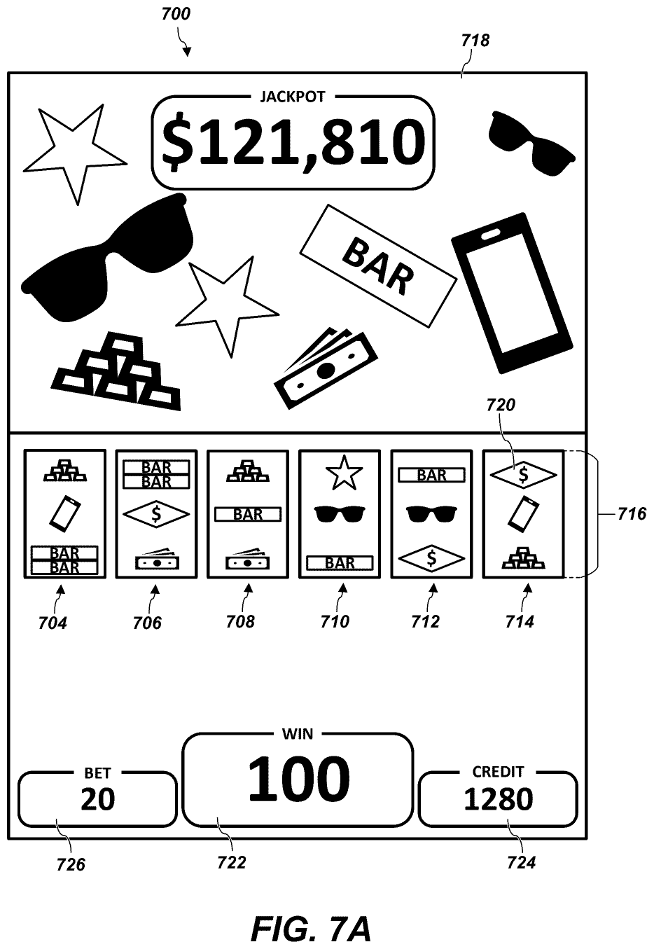

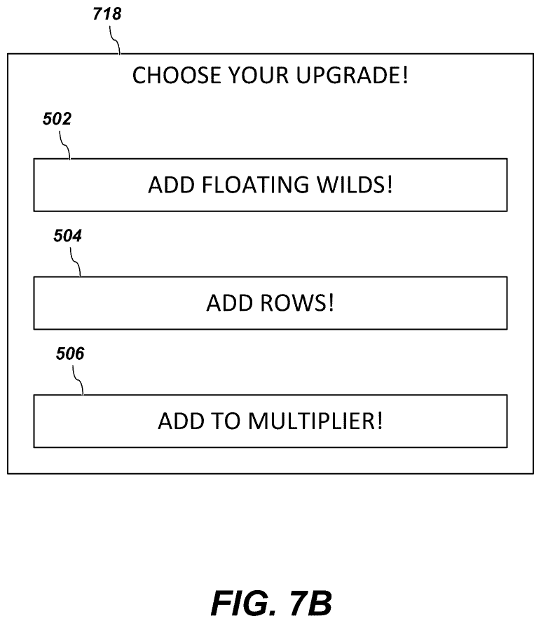

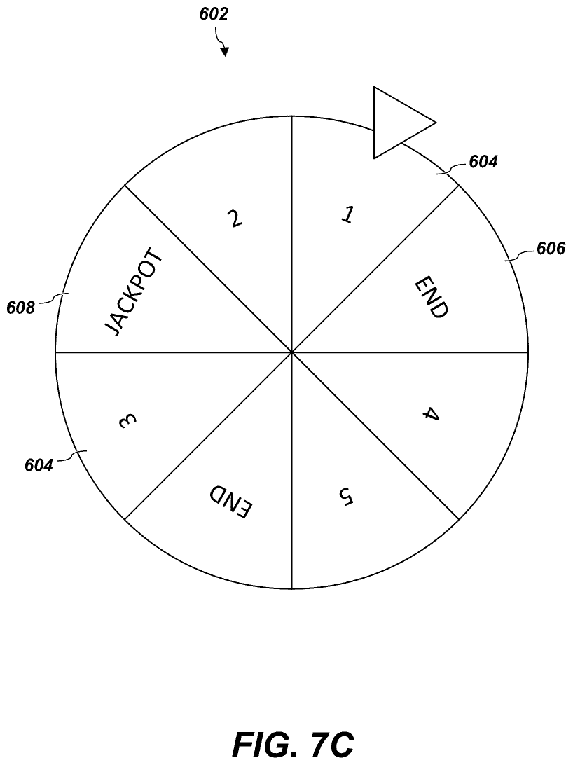

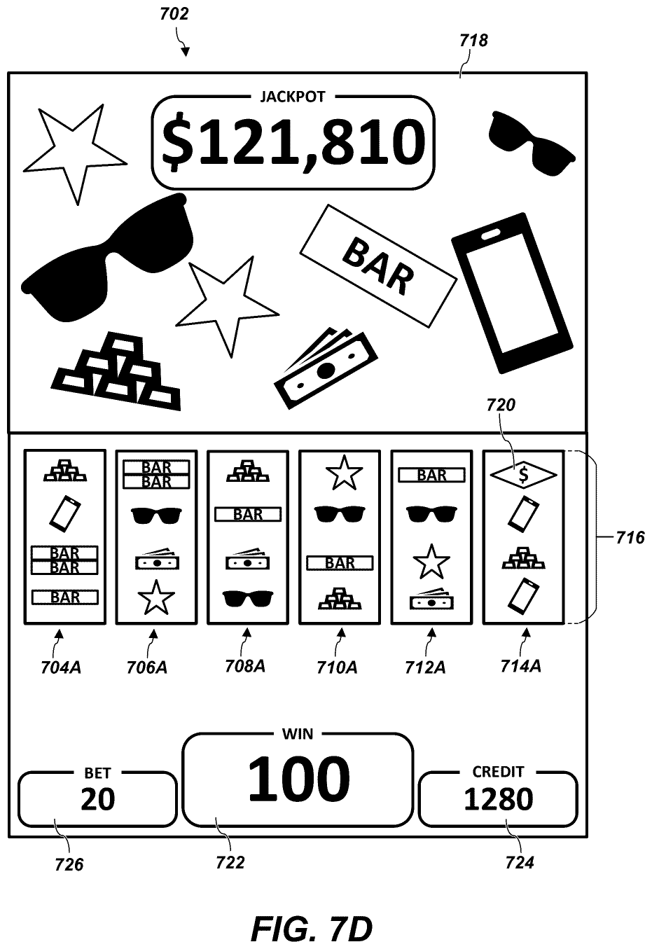

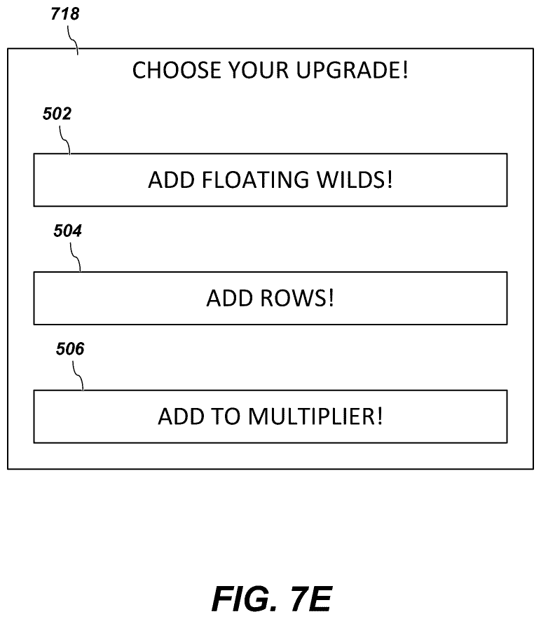

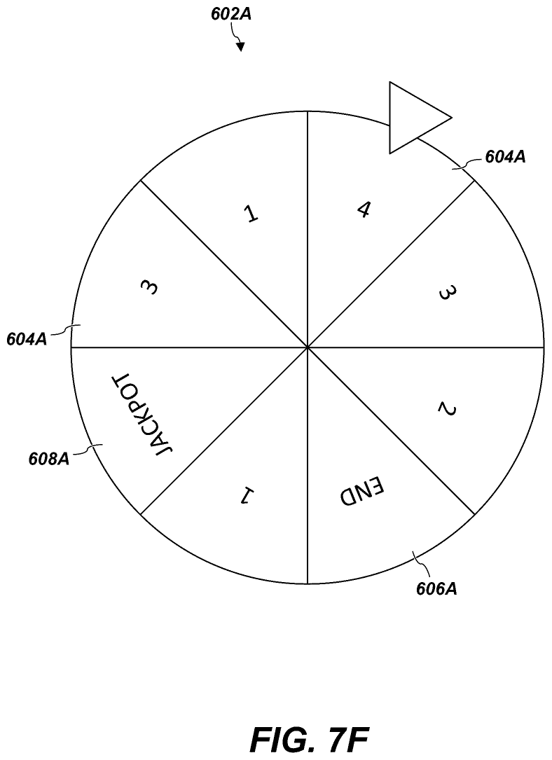

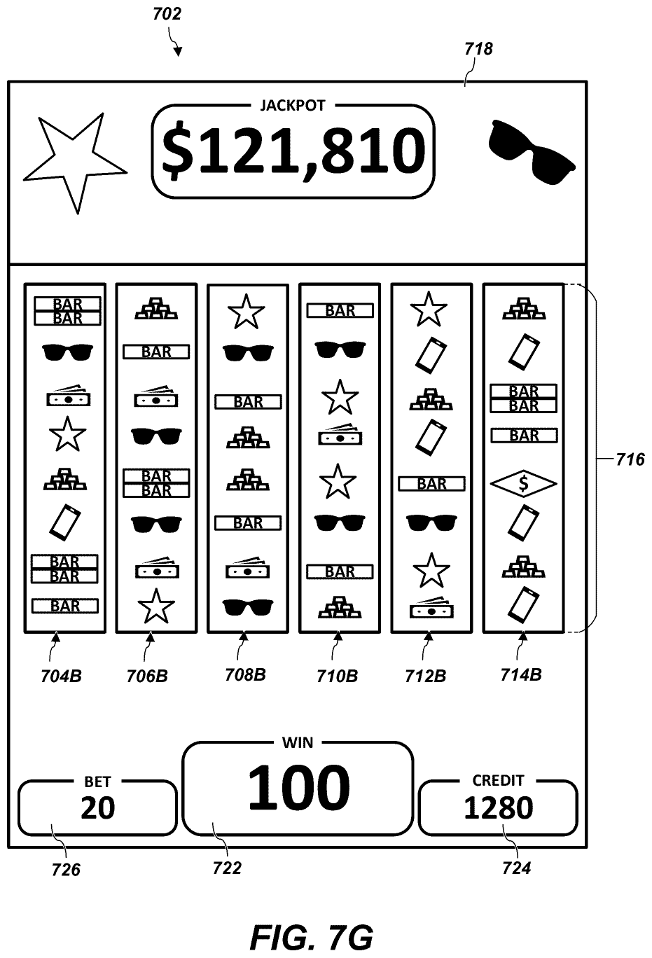

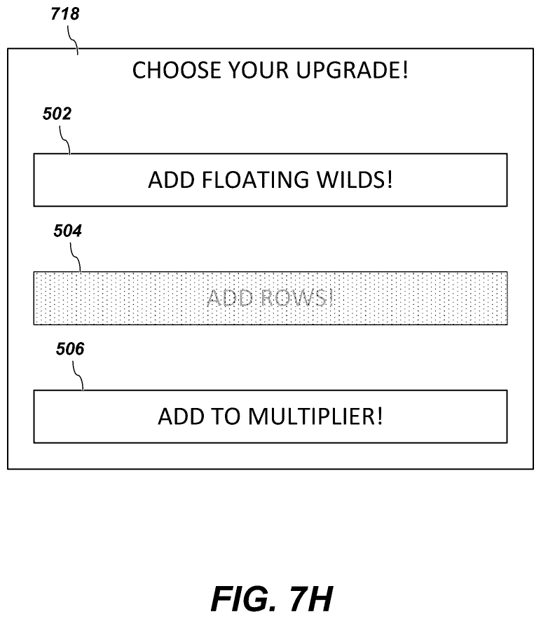

FIGS. 7A-7H are user interfaces or screen shots of a sequence between the base reel game 700 (FIG. 7A) and bonus games 702 (e.g., FIG. 7D). In exemplary embodiments, and as discussed herein, bonus games 702, and the various upgrade types included therein, are determined by the selectable options 502-506 presented to the user and the subsequent spinning of wheel 602. It is understood that similarly numbered and/or named components may function in a substantially similar fashion. Redundant explanation of these components has been omitted for brevity.

FIG. 7A is a user interface or screenshot of an example base reel game 700 played on a gaming device (e.g., gaming devices 104A-104X in FIG. 1, and/or gaming device 200 and/or mobile gaming device 256 in FIG. 2). Specifically, FIG. 7A shows a base reel game 700, in which a base reel game outcome is displayed that corresponds to (e.g., presents, represents, and/or is determined from) an output of the gaming device. The output may be a primary game outcome determined in response to a wager or credit input received from a player. In example implementations, the primary game outcome is a Class III game outcome, i.e., a Las-Vegas style game. In various implementations, the base reel game 700 may be implemented to present an outcome of any suitable game of chance. Specific details of the type of primary game outcomes presented using the base reel game 700 are not central to an understanding of the present disclosure.

The base reel game 700 may be initiated on a gaming device(s) 104A-104X, 200. Specifically, a player may fund the base reel game 700 via bill validator 234 and/or ticket reader 224. Once funded, the base reel game 700, which includes a first plurality of reels 704, 706, 708, 710, 712, 714, each including a plurality of game symbols 716, may appear on a primary display device 718. The first plurality of reels 704-714 may be physical reels and/or virtual reels. As used herein, physical reels are mechanical in nature and may be physically rotated during gameplay. In contrast, virtual reels are rendered or visually created by game controller 202 on display device 718. Display device 718 shown in FIG. 7A can correspond to, for example, a primary game display 240 and/or main display 128, 128A, and where reels 704-714 are merely animated to give the appearance of being spun. The first plurality of reels 704-714 of the example base reel game 700 include six reels. In other examples, the number of reels may range from one reel to six or more reels in number. The base reel game 700 may be played on display device 718 (e.g., display 128, 128A, 128B) of EGM 104 (see, FIG. 1). However, in other implementations, the base reel game 700 may be played on several displays including display device 718 and/or an additional one or more secondary displays.

In other implementations, the base reel game 700 may be played on a single display and/or on greater than two displays. In the example shown in FIG. 7A, the base reel game 700 includes a first reel matrix on the primary display device 718. The first reel matrix includes a plurality of symbol positions arranged in a plurality of rows and a plurality of columns. The first reel matrix may also therefore be referred to as a “matrix of symbol positions.” While, in the example shown in FIG. 7A, the first reel matrix is displayed on the primary display device 718 (e.g., display 128A), the first reel matrix may appear in other locations on an EGM 104A-104X and/or on other displays, such as, for example, the secondary display 128B, a display of button deck 120, and the like.

In the example embodiment shown in FIG. 4, the plurality of reels 704-714 form six distinct reels and/or six columns. Each reel 704-714 also includes a predetermined number of rows as well. In the example, the number of predetermined rows for each reel 704-714 during base reel game 700 includes three (3) rows. As a result, in the example embodiment, the plurality of reels 704-714 for base reel game 700 include a 3×6 arrangement, as depicted on display device 718, and include eighteen (18) game symbol positions. In other implementations, the plurality of reels 704-714 may be any size/uniformity (e.g., 2×2, 3×3, 4×4, 10×10, etc.), and a number of game symbol positions for the plurality of reels 704-714 may vary depending upon a number of rows and columns of the plurality of reels 704-714.

As described herein, during play of the base reel game 700, game symbols 716 may be selected (e.g., such as from the plurality of reels 704-714) and displayed in the game symbol positions of each column and row of the plurality of reels 704-714. Although not central to an understanding of the present disclosure, each of the plurality of reels 704-714 may include a plurality of game symbols 716 arranged in a vertical column. A number of game symbols 716 of each reel 704-714, corresponding to the number of rows of the plurality of reels 704-714, is displayed in a column of game symbol positions within the plurality of reels 704-714 during play of the base reel game 700. To display symbols from a reel within the plurality of reels 704-714, processor 204 may simulate rotation or spinning of one or more of the plurality of reels 704-714 within a respective column of the plurality of reels 704-714. Here again, however, mechanical reels having physical reel strips may be used as well. When a respective reel is simulated to halt or stop within an associated column, one or more game symbols 716 may be displayed from the reel 704-714 in the game symbol positions of the column. The game symbols 716 displayed after spinning and stopping each reel strip in a respective column of the plurality of reels 704-714 may be referred to herein as a “reel outcome” or a “base reel game outcome” or a “base game outcome.” More broadly, an “outcome” of a reel game, such as a base reel game (e.g., the base reel game 700) refers to the game symbols 716 displayed in the plurality of reels 704-714 after reel strips are spun and stopped. Thus, a rotation and stopping of a plurality of reel strips (also referred to herein as a “spin and stop sequence”) may be simulated by processor 204 within the columns of the plurality of reels 704-714 to cause a reel outcome, including a plurality of game symbols 716, to be displayed from the plurality of reel strips within the columns of the plurality of reels 704-714. Additionally, or alternatively, and as discussed herein, the base game outcome of base reel game 700 is based on an RNG pull (see, FIG. 2A) and associated reference of a lookup table.

As shown in the example of FIG. 7A, and as discussed herein, the plurality of game symbols 716 included and/or displayed within the plurality of reels 704-714 include and/or are formed from various symbol types. For example, graphic game symbols of the plurality of game symbols 716 include predetermined graphics, symbols, and/or art works that can be based on a theme, story, and/or visual representation of base reel game 700. Additionally, or alternatively, graphic game symbols 716 include suitable graphics, symbols, and/or artworks commonly associated with gaming device (e.g., “BAR,” “SPIN,” “WILD,” etc.). In an exemplary embodiment, the plurality of game symbols 716 may also include bonus game symbols 720. Bonus game symbols 720 are associated with a particular action feature. For example, bonus game symbols 720 are associated with triggering bonus wheel game 702 at the completion of base reel game 700, as discussed herein. The presence of bonus game symbol 720 (or a predetermined triggering number of action feature symbols) in base reel game 700 can indicate to a user that bonus game 702 is subsequently triggered.

Display device 718 also includes a win meter 722, a credit meter 724, and a bet meter 726. The award value won during base reel game 700 and/or bonus game 702 is displayed in win meter 722 and subsequently added to credit meter 724. The win meter 722 displays an immediately awarded value for an outcome of the base reel game 700, and the credit meter 724 displays a credit balance (calculated as a sum total of credits input and awards accrued minus wagers placed) accrued until a player cashes out. Each of the win meter 722, the credit meter 724, and bet meter 726 are shown displayed on display device 718, however, each may appear in other locations on an EGM 104A-104X or 200 and/or on other displays, such as, for example, a secondary display 128B, a display of button deck 120, and the like.

FIG. 7A is also an exemplary user interface or screen shot that triggers bonus game 702. In the exemplary embodiment, display device 718 provides the base reel game outcome displayed in base reel game 700, where the outcome includes three (3) distinct bonus game symbols 720. As discussed herein, the displaying of a predetermined number of bonus game symbols (e.g., three symbols) triggers bonus game 702 on display device 718.

Subsequent to the triggering of bonus game 702 (see, FIG. 7D), selectable options 502, 504, 506 are presented on gaming device. That is, FIG. 7B shows a user interface or screen shot of display device 718 displaying and/or presenting selectable options 502, 504, 506 after triggering bonus game 702 from the outcome of base reel game 700. As discussed herein, first selectable option 502 provides the user an opportunity to add floating wilds into bonus game 702, second selectable option 504 provides the user an opportunity to add rows in bonus game 702, and third selectable option 506 provides the user an opportunity to include and/or increase a multiplier for bonus game 702. In the exemplary embodiment shown in FIG. 7B, selectable options 502, 504, 506 are displayed and/or presented on display device 718 immediately after triggering bonus game 702 and/or are presented to the user for a first or initial time.

After the user makes a selection and/or chooses one of the selectable options 502, 504, 506, wheel 602 is subsequently presented. FIG. 7C shows a user interface or screen shot of display device 718 displaying and/or presenting wheel 602. In exemplary embodiments, wheel 602 is presented on display device 718 subsequent to the user selecting second selectable option 504, corresponding to the adding of additional rows to the plurality of reels 704, 706, 708, 710, 712, 714 during bonus game 702. Specifically, FIG. 7C depicts a wheel outcome after spinning wheel 602, where the wheel outcome identifies a single, landing position included thereon. As discussed herein, wheel 602 is specific to and/or corresponds to second selectable option 504 including the adding of additional rows to the plurality of reels 704-714 during bonus game 702. Wheel 602 displayed and/or presented on display device 718, subsequent to selecting second selectable option 504 represents the determined first state (e.g., block 408; FIG. 4) for bonus game 702. As shown, the wheel outcome depicts wheel 602 landing and/or stopping on number position 604 including a “1,” indicating to the user that a single row will be added to first plurality of reels 704-714 during bonus game 702.

FIG. 7D shows a user interface or screen shot of display device 718 displaying bonus game 702. More specifically, FIG. 7D shows display device 718 of a gaming device subsequent to the spinning of reels 704A-714A during bonus game 702. As shown in the exemplary embodiment, each of the plurality of reels 704A-714A included in bonus game 702 include four (4) rows, as a result of adding a row based on the wheel outcome for wheel 602 (see, FIG. 7C). With comparison to base reel game 700 shown in FIG. 7A, reels 704A-714A included in bonus game 702 are configured in a 4×6 arrangement, and now include twenty-four (24) game symbol positions. As discussed herein, reels 704A-714A are distinct from reels 704-714 included in base reel game 700 and are displayed and/or presented as a result of determining the first state (e.g., 1 added row) based on the wheel outcome defined by wheel 602 (see, FIG. 7C).

An outcome of the first bonus game 702, as illustrated in FIG. 7D also includes bonus game symbol 720. In exemplary embodiments, displaying of bonus game symbol 720 within an outcome of bonus game 702 indicates to a user or player that additional bonus games and/or spins follow. In other exemplary embodiments, the number of spins and/or plays of bonus game 702 are not readily identifiable to the player. As a result, the player of bonus game 702 is unaware of when and/or how many free plays of bonus game 702 they are awarded from base reel game 700. As discussed herein, the outcome of bonus game 702 is based on an RNG pull (see, FIG. 2A) and associated reference of a lookup table.

Prior to a second or subsequent play of bonus game 702 (see, FIG. 7G), selectable options 502, 504, 506 are once again presented on gaming device. More specifically, FIG. 7E shows a user interface or screen shot of display device 718 displaying and/or presenting selectable options 502, 504, 506 after the first play of bonus game 702 (see, FIG. 7D).

FIG. 7F shows a user interface or screen shot of display device 718 displaying and/or presenting wheel 602A. In exemplary embodiments, wheel 602A is presented on display device 718 subsequent to the user again selecting second selectable option 504, corresponding to the adding of additional rows to the plurality of reels 704, 706, 708, 710, 712, 714 during bonus game 702. With comparison to FIG. 7C, wheel 602A includes distinct values included in number positions 604A and/or includes a distinct positioning and/or number of one or more end positions 606A and one or more jackpot positions 608A. In exemplary embodiments, FIG. 7F depicts a wheel outcome after spinning wheel 602A, where the wheel outcome identifies a single, landing position included thereon. Similar to wheel 602 (see, FIG. 7C), wheel 602A is specific to and/or corresponds to second selectable option 504 including the adding of additional rows to the plurality of reels 704-714 during bonus game 702. Wheel 602A displayed and/or presented on display device 718, subsequent to selecting second selectable option 504 for a second time, represents the determined second state (e.g., block 418; FIG. 4) for bonus game 702. As shown, the wheel outcome depicts wheel 602A landing and/or stopping on number position 604A including a “4,” indicating to the user that four (4) rows will be added to the plurality of reels 704A-714A within bonus game 702.

In exemplary embodiments, and as discussed herein, numerical values included in number positions 604, 604A of wheel 602, 602A are distinct as bonus game 702 progresses. More specifically, in each instance of bonus game 702 where a user or player selects one of the selectable options for a second or subsequent time, wheel 602A presented during the subsequent instance includes distinct numerical values in number positions 604A. Additionally in the exemplary embodiment, the numerical values included in number positions 604A of wheel 602A are adjusted, changed, and/or account for previous wheel outcomes during past wheel spins (e.g., FIG. 7C). Continuing the example discussed herein, a maximum number of rows that can be added to reels 704-714 during bonus game 702 is five (5). As a result, the largest reel configuration and/or arrangement for reels 704-714 in bonus game 702 includes an 8×6 arrangement. When a player selects second selectable option 504 (see, FIG. 7B), displayed wheel 602 presented for the first time includes the possibility of adding five (5) rows (see, FIG. 7C). During a subsequent play of bonus game 702 and/or subsequent to the player selecting second selectable option 504 for a second time (see, FIG. 7E), wheel 602A presented for a second time adjusts the numerical value corresponding to the number of rows that can be added to reels 704-714 during bonus game 702 based on the previous wheel outcome (see, FIG. 7C). For example, if a first wheel outcome includes a single row being added to bonus game 702 (see, FIG. 7D), wheel 602A does not include and/or display a numerical value greater than four (4) during the second or subsequent spin, as reels 704A-714A cannot add more than four (4) rows (e.g., maximum 8×6 configuration). In exemplary embodiments, the numerical values are dynamically changed on wheel 602, 602A based on previous outcomes during bonus game 702, or alternatively, a plurality of wheels 602, 602A are stored and subsequently displayed based on a prior wheel outcome.

FIG. 7G shows a user interface or screen shot of display device 718 displaying bonus game 702. More specifically, FIG. 7G shows display device 718 of a gaming device subsequent to the spinning of reels 704B-714B during bonus game 702. As shown in the exemplary embodiment, each of the plurality of reels 704B-714B included in bonus game 702 include eight (8) rows, as a result of adding four (4) rows based on the wheel outcome for wheel 602A (see, FIG. 7F). As such, reels 704B-714B included in bonus game 702 are configured in an 8×6 arrangement, and now include forty-eight (48) game symbol positions. As discussed herein, and similar to reels 704A-714A, reels 704B-714B are distinct from reels 704-714 included in base reel game 700 and are displayed and/or presented as a result of determining the second state (e.g., 4 added rows) based on the wheel outcome defined by wheel 602A (see, FIG. 7F).

FIG. 7H shows a user interface or screen shot of display device 718 displaying and/or presenting selectable options 502, 504, 506 after the second play of bonus game 702 (see, FIG. 7G), and/or prior to a third play of bonus game 702. In the exemplary embodiment, second selectable option 504 is “dimmed” and/or “shaded out.” The dimming and/or shading of the second selectable option 504 indicates to the player of bonus game 702 that the dimmed second selectable option 504 is not available and/or cannot be selected during the third play of bonus game 702. That is, and as a result of reels 704B-714B including the maximum size configuration (e.g., 8×6 arrangement) (see, FIG. 7G), no additional rows can be added to reels 704B-714B during subsequent plays of bonus game 702. As such, second selectable option 504 is dimmed and/or unavailable for selection by the player during a third or subsequent play of bonus game 702. The player can only select first selectable option 502 or third selectable option 506.

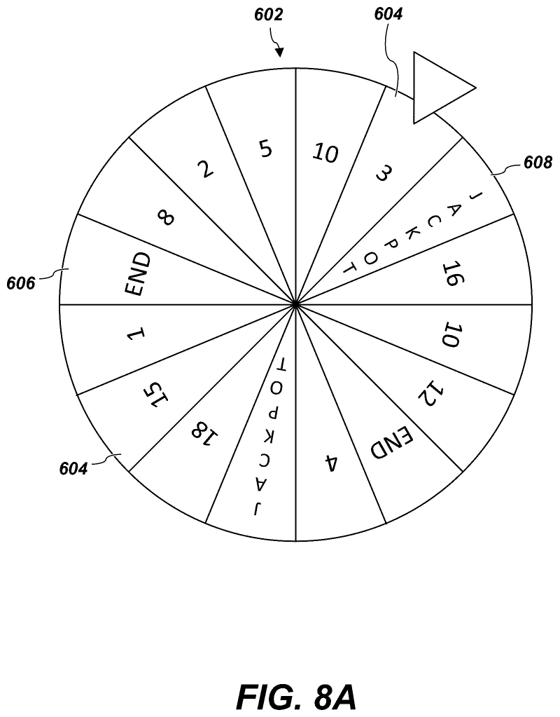

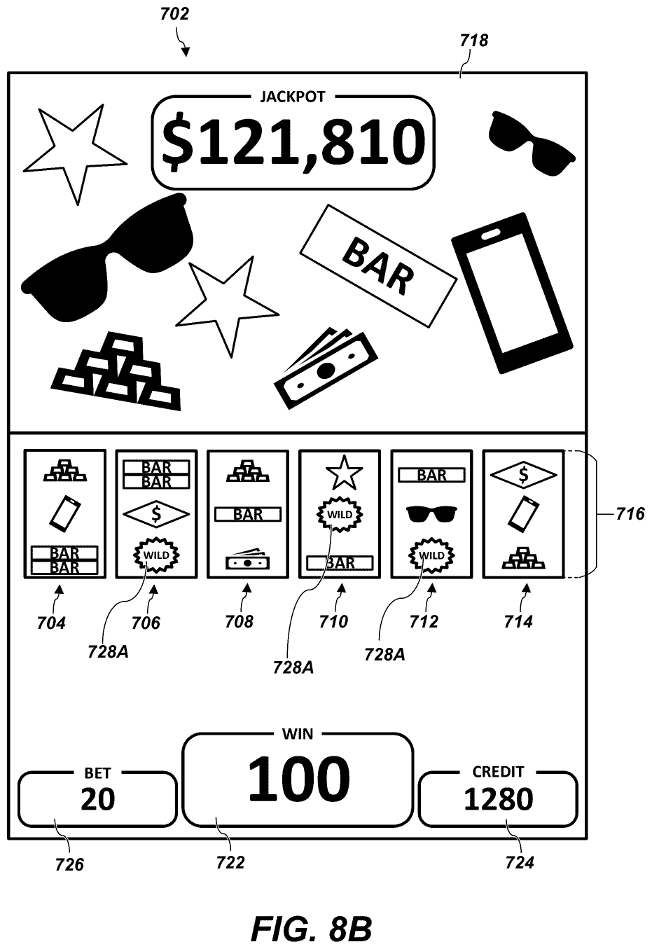

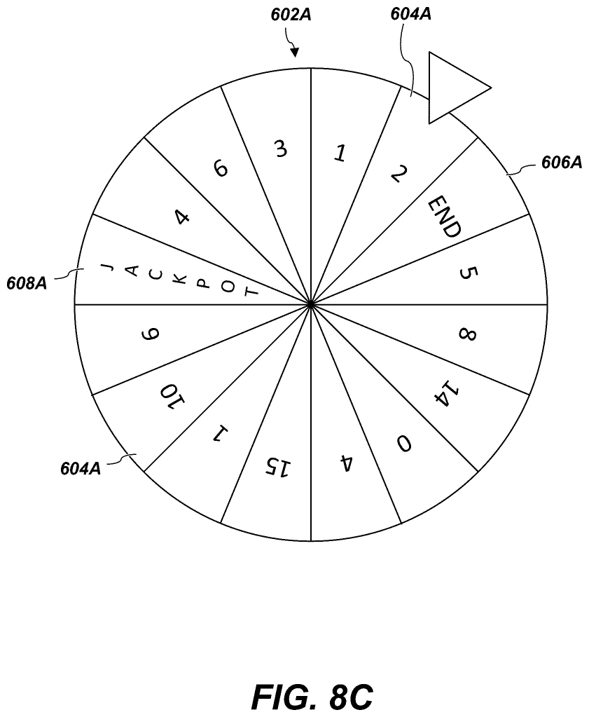

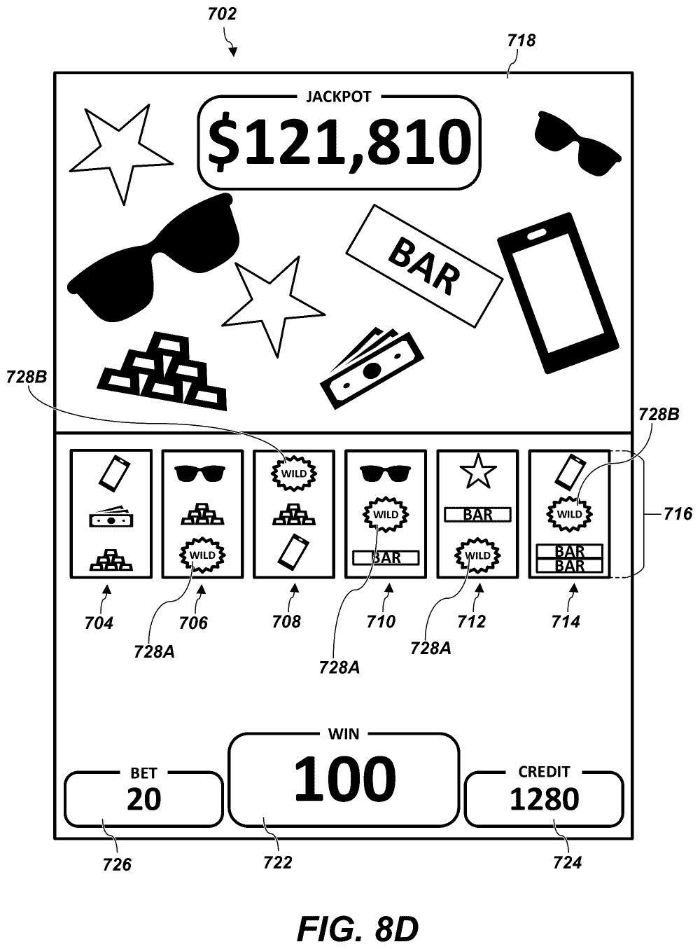

FIGS. 8A-8D are user interfaces or screen shots of a sequence of bonus games 702 and the selection of the first selectable option 502. It is understood that similarly numbered and/or named components may function in a substantially similar fashion. Redundant explanation of these components has been omitted for brevity.

FIG. 8A shows a user interface or screen shot of display device 718 displaying and/or presenting wheel 602 after a user or player makes a selection and/or chooses one of the selectable options 502, 504, 506. In exemplary embodiments, wheel 602 is presented on display device 718 subsequent to the user selecting first selectable option 502, corresponding to the adding of floating wilds in bonus game 702. Specifically, FIG. 8A depicts a wheel outcome after spinning wheel 602, where the wheel outcome identifies a single, landing position included thereon. As discussed herein, wheel 602 is specific to and/or corresponds to first selectable option 502 including the adding of floating wild symbols (see, FIG. 8B) to the plurality of reels 704-714 during bonus game 702. Wheel 602 displayed and/or presented on display device 718, subsequent to selecting first selectable option 502 represents the determined first state (e.g., block 408; FIG. 4) for bonus game 702. As shown, the wheel outcome depicts wheel 602 landing and/or stopping on number position 604 including a “3,” indicating to the user that three (3) distinct floating wild symbols will be added to first plurality of reels 704-714 during bonus game 702.

FIG. 8B shows a user interface or screen shot of display device 718 displaying bonus game 702. More specifically, FIG. 8B shows display device 718 of a gaming device subsequent to the spinning of reels 704-714 during bonus game 702. As shown in the exemplary embodiment, at least a portion of the plurality of reels 704-714 included in bonus game 702 include floating wild symbols 728A, as a result of the wheel outcome for wheel 602 (see, FIG. 8B) awarding three (3) floating wild symbols 728. For example, reels 706, 710, 712 each include one floating wild symbol 728A included therein. As similarly discussed herein, reels 704-714 shown in bonus game 702 including floating wide symbols 728 are distinct from reels 704-714 included in base reel game 700 and/or are displayed or presented as a result of determining the first state (e.g., add three (3) floating wild symbols) based on the wheel outcome defined by wheel 602 (see, FIG. 8A).

FIG. 8C shows a user interface or screen shot of display device 718 displaying and/or presenting wheel 602A. In exemplary embodiments, wheel 602A is presented on display device 718 subsequent to the user again selecting first selectable option 502, corresponding to the adding floating wild symbols 728 to the plurality of reels 704, 706, 708, 710, 712, 714 during bonus game 702. With comparison to FIG. 8A, wheel 602A includes distinct values included in number positions 604A and/or includes a distinct positioning and/or number of one or more end positions 606A and one or more jackpot positions 608A. In exemplary embodiments, FIG. 8C depicts a wheel outcome after spinning wheel 602A, where the wheel outcome identifies a single, landing position included thereon. Wheel 602A displayed and/or presented on display device 718, subsequent to selecting first selectable option 502 for a second time, represents the determined second state (e.g., block 418; FIG. 4) for bonus game 702. As shown, the wheel outcome depicts wheel 602A landing and/or stopping on number position 604A including a “2,” indicating to the user that two (2) additional floating wild symbols 728B will be added to the plurality of reels 704A-714A within bonus game 702.

Similar to exemplary embodiments discussed herein with respect to FIGS. 7A-7H, numerical values included in number positions 604, 604A of wheel 602, 602A are distinct as bonus game 702 progresses. More specifically, in each instance of bonus game 702 where a user or player selects one of the selectable options for a second or subsequent time, wheel 602A presented during the subsequent instance includes distinct numerical values in number positions 604A. Additionally in the exemplary embodiment, the numerical values included in number positions 604A of wheel 602A are adjusted, changed, and/or account for previous wheel outcomes during past wheel spins (e.g., FIG. 8A). Continuing the example discussed herein, a maximum number of floating wild symbols that can be added to reels 704-714 during bonus game 702 is based on the configuration and/or arrangement of reels 704-714. For example, where the reel configuration and/or arrangement for reels 704-714 in bonus game 702 includes an 3×6 arrangement, the maximum number of floating wild symbols 728 that can be awarded during bonus game 702 is eighteen (18). As discussed herein, and during a subsequent play of bonus game 702 and/or subsequent to the player selecting first selectable option 502 for a second time (see, FIG. 8C), wheel 602A presented for a second time adjusts the numerical value corresponding to the number of floating wild symbols 428 that can be added to reels 704-714 during bonus game 702 based on the previous wheel outcome (see, FIG. 8A).

FIG. 8D shows a user interface or screen shot of display device 718 displaying bonus game 702. More specifically, FIG. 8D shows display device 718 of a gaming device subsequent to the second spinning of reels 704-714 during bonus game 702. As shown in the exemplary embodiment, floating wild symbols 728A awarded based on the first wheel outcome of spinning wheel 602 (see, FIG. 8A) are maintained and/or are persistent within reels 706, 710, 712 during subsequent plays of bonus game 702. Additionally, and as a result of the wheel outcome for wheel 602A (see, FIG. 8C) awarding two (2) more floating wild symbols 728B, reels 708, 714 also include and/or display floating wild symbols 728B. For any subsequent plays of bonus game 702, floating wild symbols 728A, 728B are persistent and/or remain displayed within reels 704-714, regardless of what other option types (e.g., add rows, add multipliers) are selected by the user.

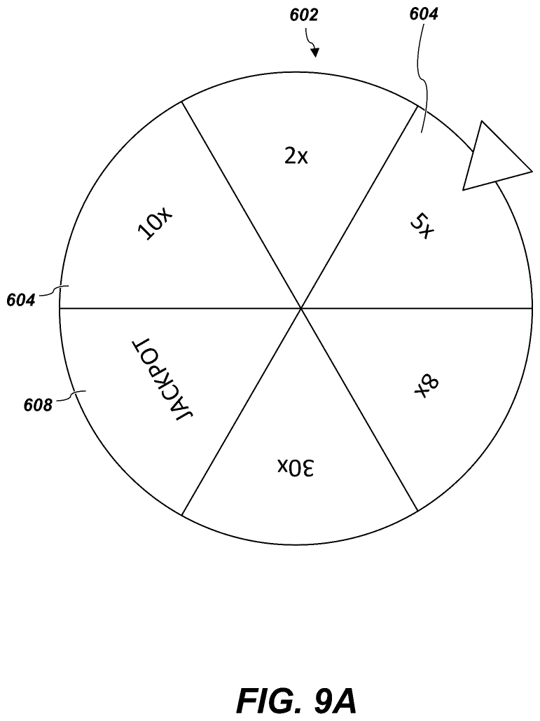

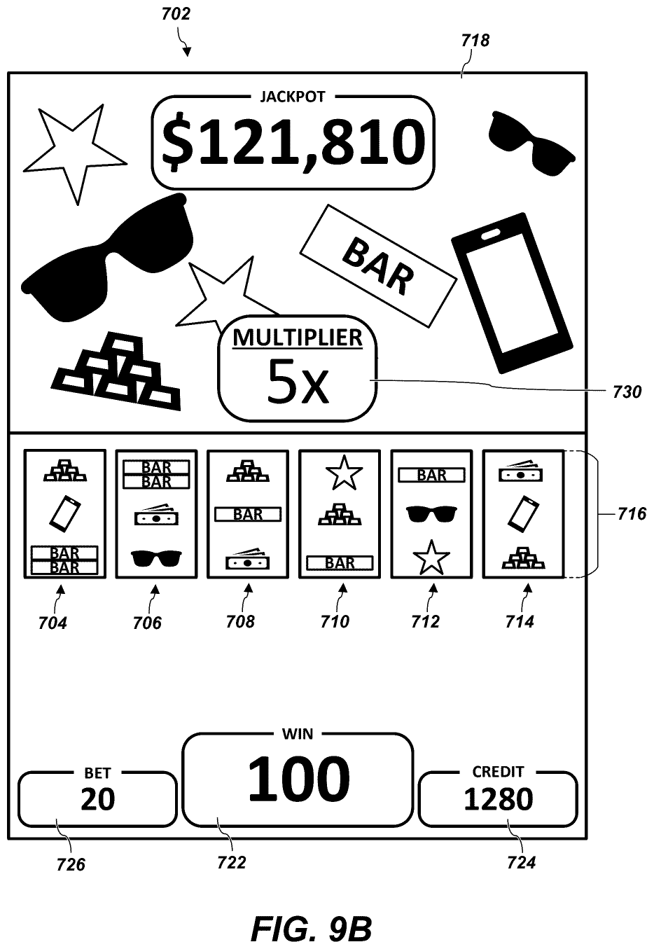

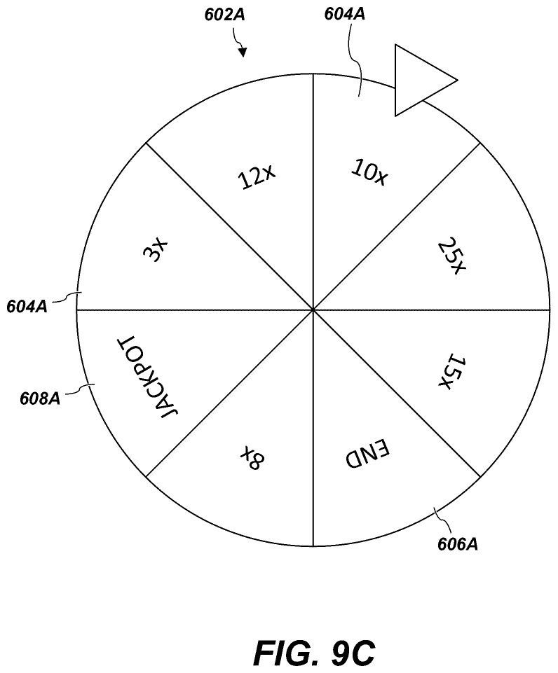

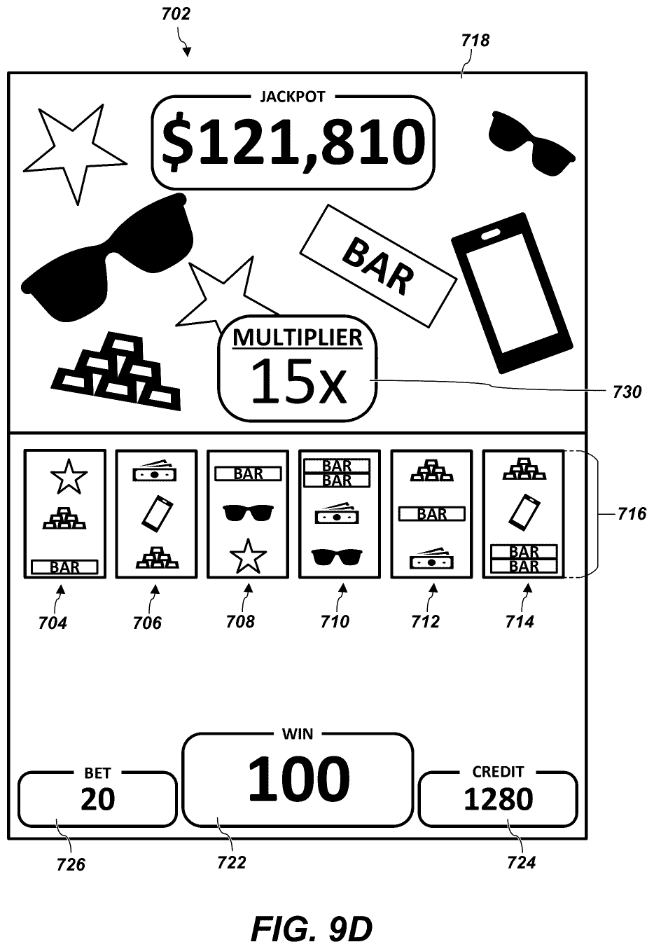

FIGS. 9A-9D are user interfaces or screen shots of a sequence of bonus games 702 and the selection of the third selectable option 506. It is understood that similarly numbered and/or named components may function in a substantially similar fashion. Redundant explanation of these components has been omitted for brevity.

FIG. 9A shows a user interface or screen shot of display device 718 displaying and/or presenting wheel 602 after a user or player makes a selection and/or chooses one of the selectable options 502, 504, 506. In exemplary embodiments, wheel 602 is presented on display device 718 subsequent to the user selecting third selectable option 506, corresponding to including multipliers in bonus game 702. Specifically, FIG. 9A depicts a wheel outcome after spinning wheel 602, where the wheel outcome identifies a single, landing position included thereon. As discussed herein, wheel 602 is specific to and/or corresponds to third selectable option 506 configured to add multipliers (see, FIG. 9B) to the outcome of bonus game 702. Wheel 602 displayed and/or presented on display device 718, subsequent to selecting third selectable option 506, represents the determined first state (e.g., block 408; FIG. 4) for bonus game 702. As shown, the wheel outcome depicts wheel 602 landing and/or stopping on number position 604 including a “5×,” indicating to the user that a five times multiplier will be applied to an outcome of bonus game 702. As discussed herein, displaying multiple multipliers while playing bonus game 702 results in a cumulative multiplier to be applied to the outcome of bonus game 702.

FIG. 9B shows a user interface or screen shot of display device 718 displaying bonus game 702. More specifically, FIG. 9B shows display device 718 of a gaming device subsequent to the spinning of reels 704-714 during bonus game 702. As shown in the exemplary embodiment, display device 718 presents the awarded multiplier (e.g., 5×) in a multiplier notification 730 during bonus game 702. In an exemplary embodiment where bonus game 702 ends after the spinning of reels 704-714, as shown in FIG. 9B, an award associated with the outcome of bonus game 702 is subsequently multiplied by the multiplier value including in multiplier notification 730, before being awarded to the player. In another exemplary embodiment where additional plays of bonus game 702 are awarded, any subsequently awarded multipliers are added to previously awarded multipliers, as discussed herein.

FIG. 9C shows a user interface or screen shot of display device 718 displaying and/or presenting wheel 602A. In exemplary embodiments, wheel 602A is presented on display device 718 subsequent to the user again selecting third selectable option 504, corresponding to awarding multipliers to bonus game 702. With comparison to FIG. 8A, wheel 602A includes distinct values included in number positions 604A and/or includes a distinct positioning and/or number of one or more end positions 606A and one or more jackpot positions 608A. Additionally, and as shown in FIG. 9C, wheel 602A includes a distinct number of landing positions that is different than wheel 602. More specifically, wheel 602 shown in FIG. 9A includes six (6) distinct landing positions, while wheel 602A includes eight (8) distinct landing positions. In exemplary embodiments, FIG. 9C depicts a wheel outcome after spinning wheel 602A, where the wheel outcome identifies a single, landing position included thereon. Wheel 602A displayed and/or presented on display device 718, subsequent to selecting third selectable option 506 for a second time, represents the determined second state (e.g., block 418; FIG. 4) for bonus game 702. As shown, the wheel outcome depicts wheel 602A landing and/or stopping on number position 604A including a “10×,” indicating to the user that an additional ten times multiplier will be added to the previously awarded multiplier for bonus game 702.

Similar to exemplary embodiments discussed herein with respect to FIGS. 7A-7H, numerical values included in number positions 604, 604A of wheel 602, 602A are distinct as bonus game 702 progresses. More specifically, in each instance of bonus game 702 where a user or player selects one of the selectable options for a second or subsequent time, wheel 602A presented during the subsequent instance includes distinct numerical values in number positions 604A. Additionally in the exemplary embodiment, the numerical values included in number positions 604A of wheel 602A are adjusted, changed, and/or account for previous wheel outcomes during past wheel spins (e.g., FIG. 8A). Continuing the example discussed herein, a maximum multiplier number that can be added to bonus game 702 is thirty times (30×) the awarded value. As discussed herein, and during a subsequent play of bonus game 702 and/or subsequent to the player selecting third selectable option 506 for a second time (see, FIG. 9C), wheel 602A presented for a second time adjusts the numerical value corresponding to the multipliers to be added to bonus game 702 based on the previous wheel outcome (see, FIG. 9A). In exemplary embodiments shown, wheel 602A does not include any numerical value greater than 25× after awarding a 5× multiplier from the wheel outcome determined by wheel 602 (see, FIG. 9A).

FIG. 9D shows a user interface or screen shot of display device 718 displaying bonus game 702. More specifically, FIG. 9D shows display device 718 of a gaming device subsequent to the second spinning of reels 704-714 during bonus game 702. As shown in the exemplary embodiment, display device 718 presents the cumulative awarded multiplier (e.g., 15×) in multiplier notification 730 during bonus game 702. That is, the subsequently awarded 10× multiplier awarded based on the wheel outcome of wheel 602A (see, FIG. 9C) is added to the previously awarded 5× multiplier awarded based on the wheel outcome of wheel 602 (see, FIG. 9A). As such, during the second play of bonus game 702, the multiplier that can be applied to the outcome of bonus game 702 is equal to a fifteen times (15×) multiplier.

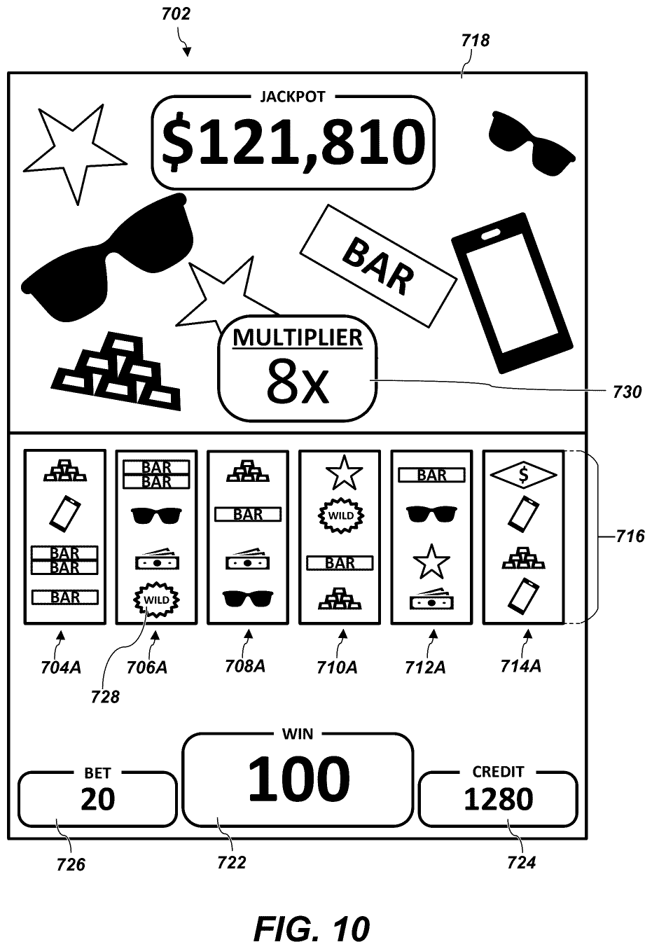

FIG. 10 shows a user interface or screen shot of display device 718 displaying bonus game 702 and a third bonus game outcome. In the exemplary embodiment, and during each distinct round of play of bonus game 702, the player or user selects a distinct upgrade type. For example, during the first play of bonus game 702, the second selectable option 504 corresponding to adding rows to reels 704-714 for bonus game 702 is selected. As shown in FIG. 10, one (1) additional row is added in bonus game 702, and reels 704-714A are displayed and/or include a 4×6 arrangement. During a second play of bonus game 702 the first selectable option 502 corresponding to adding floating wild symbols 728 is selected, and two (2) floating wild symbols 728 are added to reels 706A and 710A. Finally, during the third play of bonus game 702, the third selectable option 506 corresponding to including a multiplier for bonus game 702 is selected. In the exemplary embodiment shown in FIG. 10, multiplier notification 730 indicates that an eight times (8×) multiplier has been awarded for bonus game 702.

Although shown in FIG. 10 as including three rounds or plays of bonus game 702, it is understood that bonus game 702 can include more or less plays. Furthermore, it is understood that any combination of upgrade types can be selected by the player, via selectable options 502, 504, 506, during bonus game 702, including the selection of one, two, or all three upgrade types. Additionally, and until the selectable options and corresponding upgrade types reach the maximum value (e.g., maximum 30× multiplier), the player can select the same upgrade type multiple times during bonus game 702.

A computer, controller, or server, such as those described herein, includes at least one processor or processing unit and a system memory. The computer, controller, or server typically has at least some form of computer readable non-transitory media. As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits “configured to” carry out programmable instructions, and these terms are used interchangeably herein. In the implementations described herein, memory may include, but is not limited to, a computer-readable medium or computer storage media, volatile and nonvolatile media, removable and non-removable media implemented in any method or technology for storage of information such as computer readable instructions, data structures, program modules, or other data. Such memory includes a random access memory (RAM), computer storage media, communication media, and a computer-readable non-volatile medium, such as flash memory. Alternatively, a floppy disk, a compact disc—read only memory (CD-ROM), a magneto-optical disk (MOD), and/or a digital versatile disc (DVD) may also be used. Also, in the implementations described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary implementation, additional output channels may include, but not be limited to, an operator interface monitor.

As indicated above, the process may be embodied in computer software. The computer software could be supplied in a number of ways, for example on a tangible, non-transitory, computer readable storage medium, such as on any nonvolatile memory device (e.g. An EEPROM). Further, different parts of the computer software can be executed by different devices, such as, for example, in a client-server relationship. Persons skilled in the art will appreciate that computer software provides a series of instructions executable by the processor.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
at least one memory storing a plurality of sets of reel strips; and
at least one processor in communication with the at least one memory, the at least one processor configured to:
in response to a bonus game being triggered, cause a display device to prompt selection of an upgrade type of a plurality of upgrade types;
receive a selection of a first upgrade type of the plurality of upgrade types;
randomly determine a first upgrade based on the first upgrade type;
determine a first state based on the first upgrade type or the first upgrade;
select a first set of reel strips of the plurality of sets of reel strips based on the first state; and
generate and cause the display device to display in a game matrix a first game outcome based on the first set of reel strips and the first upgrade.

2. The electronic gaming system of claim 1, wherein the at least one processor is further configured to:
in response to displaying the first game outcome, cause a display device to prompt selection of an upgrade type of the plurality of upgrade types;
receive a selection of a second upgrade type of the plurality of upgrade types;
randomly determine a second upgrade based on the second upgrade type;
determine a second state based on the first state and on the second upgrade type or the second upgrade;
select a second set of reel strips of the plurality of sets of reel strips based on the second state; and
generate and cause the display device to display in the game matrix a second game outcome based on the second set of reel strips and the second upgrade.

3. The electronic gaming system of claim 1, wherein the plurality of upgrade types include floating wilds, adding rows, and a multiplier.

4. The electronic gaming system of claim 3, wherein the first upgrade type is floating wilds, and wherein to randomly determine the first upgrade, the at least one processor is configured to:
randomly determine a number of floating wilds to display; and
randomly determine positions within the game matrix to display the floating wilds.

5. The electronic gaming system of claim 3, wherein the first upgrade type is adding rows, and wherein to randomly determine the first upgrade, the at least one processor is configured to randomly determine a number of rows to add to the game matrix.

6. The electronic gaming system of claim 3, wherein the first upgrade type is a multiplier, and wherein to randomly determine the first upgrade, the at least one processor is configured to randomly determine a number by which to increment the multiplier.

7. The electronic gaming system of claim 1, wherein the at least one processor is further configured to, in response to determining the first upgrade, cause the display device to display a wheel animation associated with the first upgrade.

8. A method for providing user-selectable persistent upgrades in a bonus game, the method performed by at least one processor in communication with at least one memory storing a plurality of sets of reels strips, the method comprising:
in response to a bonus game being triggered, causing a display device to prompt selection of an upgrade type of a plurality of upgrade types;
receiving a selection of a first upgrade type of the plurality of upgrade types;
randomly determining a first upgrade based on the first upgrade type;
determining a first state based on the first upgrade type or the first upgrade;
selecting a first set of reel strips of the plurality of sets of reel strips based on the first state; and
generating and causing the display device to display in a game matrix a first game outcome based on the first set of reel strips and the first upgrade.

9. The method of claim 8, further comprising:
in response to displaying the first game outcome, causing a display device to prompt selection of an upgrade type of the plurality of upgrade types;
receiving a selection of a second upgrade type of the plurality of upgrade types;
randomly determining a second upgrade based on the second upgrade type;
determining a second state based on the first state and on the second upgrade type or the second upgrade;
selecting a second set of reel strips of the plurality of sets of reel strips based on the second state; and
generating and causing the display device to display in the game matrix a second game outcome based on the second set of reel strips and the second upgrade.

10. The method of claim 8, wherein the plurality of upgrade types include floating wilds, adding rows, and a multiplier.

11. The method of claim 10, wherein the first upgrade type is floating wilds, and wherein randomly determining the first upgrade comprises:
randomly determining a number of floating wilds to display; and
randomly determine positions within the game matrix to display the floating wilds.

12. The method of claim 10, wherein the first upgrade type is adding rows, and wherein randomly determining the first upgrade comprises randomly determining a number of rows to add to the game matrix.

13. The method of claim 10, wherein the first upgrade type is a multiplier, and wherein randomly determining the first upgrade comprises randomly determining a number by which to increment the multiplier.

14. The method of claim 8, further comprising, in response to determining the first upgrade, causing the display device to display a wheel animation associated with the first upgrade.

15. At least one non-transitory computer-readable storage media having computer-executable instructions embodied thereon, wherein when executed by at least one processor in communication with at least one memory storing a plurality of sets of reels strips, the computer-executable instructions cause the at least one processor to:
in response to a bonus game being triggered, cause a display device to prompt selection of an upgrade type of a plurality of upgrade types;
receive a selection of a first upgrade type of the plurality of upgrade types;
randomly determine a first upgrade based on the first upgrade type;
determine a first state based on the first upgrade type or the first upgrade;
select a first set of reel strips of the plurality of sets of reel strips based on the first state; and
generate and cause the display device to display in a game matrix a first game outcome based on the first set of reel strips and the first upgrade.

16. The at least one non-transitory computer-readable storage media of claim 15, wherein the computer-executable instructions further cause the at least one processor to:
in response to displaying the first game outcome, cause a display device to prompt selection of an upgrade type of the plurality of upgrade types;
receive a selection of a second upgrade type of the plurality of upgrade types;
randomly determine a second upgrade based on the second upgrade type;
determine a second state based on the first state and on the second upgrade type or the second upgrade;
select a second set of reel strips of the plurality of sets of reel strips based on the second state; and
generate and cause the display device to display in the game matrix a second game outcome based on the second set of reel strips and the second upgrade.

17. The at least one non-transitory computer-readable storage media of claim 15, wherein the plurality of upgrade types include floating wilds, adding rows, and a multiplier.

18. The at least one non-transitory computer-readable storage media of claim 17, wherein the first upgrade type is floating wilds, and wherein to randomly determine the first upgrade, the computer-executable instructions further cause the at least one processor to:
randomly determine a number of floating wilds to display; and
randomly determine positions within the game matrix to display the floating wilds.

19. The at least one non-transitory computer-readable storage media of claim 17, wherein the first upgrade type is adding rows, and wherein to randomly determine the first upgrade, the computer-executable instructions further cause the at least one processor to randomly determine a number of rows to add to the game matrix.

20. The at least one non-transitory computer-readable storage media of claim 17, wherein the first upgrade type is a multiplier, and wherein to randomly determine the first upgrade, the computer-executable instructions further cause the at least one processor to randomly determine a number by which to increment the multiplier.
